(19) United States
(12) Patent Application Publication
(10) Pub. No.: US 2016/0154429 A1
(43) Pub. Date: Jun. 2, 2016

(54) SYSTEM AND METHOD FOR SECURING AN ELECTRONIC DEVICE

(71) Applicant: Mark Mansoor, Newton, MA (US)

(72) Inventor: Mark Mansoor, Newton, MA (US)

(21) Appl. No.: 14/557,762

(22) Filed: Dec. 2, 2014

(51) Int. Cl. G06F 1/16; G09F 3/00

(52) U.S. Cl. CPC G06F 1/1628; G09F 3/00

(57) ABSTRACT

An apparatus for securing an electronic device comprises a body having opposing surfaces; a port configured to receive a portion of the electronic device; and a compressive member configured to securely retain the portion of the electronic device within the port. A system for securing an electronic device comprises a first surface, a raised portion having a port configured to receive a portion of the electronic device, and an area on the first surface adjacent to the raised portion on which printed material may be provided. A method for securing an electronic device comprising providing a structure having a port for securely receiving an electronic device; inserting a portion of the electronic device into the port; and applying a compressive force within the port in a manner to restrict movement of the electronic device.

### TECHNICAL FIELD

The present invention relates to electronic devices, and more particularly, an apparatus and system for securing an electronic device.

### BACKGROUND

Electronic devices, such memory sticks, electronic adapters, and wireless streaming devices, are often easily transportable, configured to interface with a variety of electronics, and have a vast number of valuable uses. As just one example, memory sticks may be loaded with informational materials and distributed to potential clients for marketing purposes. Unfortunately, much like business cards, these devices are often lost or misplaced due to their small size and for lack of a convenient means to transport the device or organize it along with similar devices. Further, these devices may be discarded for lack of a readily apparent printed “teaser” enticing the potential client to connect the device to a computer and review the materials stored thereon. Similarly, memory sticks may contain other important information, such as work files, personal files, and entertainment media (movies, music albums, etc.). For similar reasons, these devices may be lost, misplaced, thrown in a junk drawer, or confused with other similar devices, rendering them somewhat undesirable as electronic storage media.

Current systems for securing electronic devices have some disadvantages. In one aspect, components used in existing packaging systems may have large footprints, and may be poorly combined, thereby inefficiently using available surface space. In a marketing or media sales context, it may be desirable to provide a way to secure and package an electronic device in a compact manner that maximizes available surface space for displaying associated printed material like marketing collateral. In a storage context, it may be desirable to provide a way to secure and package one or more electronic devices in a compact, organized, and transportable manner having adequate surface space for labels describing information associated with each device, such as contents, specifications, and/or security credentials. In a shipping/distribution context, it may be desirable to provide a way to compactly secure multiple electronic devices to a single member, or to stack multiple packages, each securing one or more electronic devices, compactly within a given volume.

In another aspect, existing packaging systems may suffer from structural weakness that may damage the electronic device and/or the packaging itself. Binder-type packages, and electronic devices stored within them, may be easily bowed or crushed by external forces given the cantilevered nature of the front and back covers from the spine. Similarly, binder-type packages may comprise a non-symmetrical shape when closed, making the task of stacking of multiple binders difficult and tedious, as well as rendering the packaging cheap-looking or unattractive.

In yet another aspect, existing systems may fail to secure electronic devices in a reliable manner. Many rely on a friction fit between the electronic device and a preformed retaining element. Improper manufacturing tolerances, wear and tear, and warping may lead to decreased reliability of these elements. Further, these elements are limited to receiving only the specific kind of electronic device for which it was designed. It may be desirable to provide a way to reliably secure a specific type of electronic device, as well as reliably secure a variety of electronic devices with a single apparatus.

In light of these issues, it would be desirable to provide a way to secure and package one or more electronic devices in a robust, attractive, and space efficient manner for marketing, storage, shipping and other applications.

### SUMMARY OF THE INVENTION

The present disclosure is directed to an apparatus for securing an electronic device, the apparatus comprising a body having opposing surfaces; a port extending into the body and configured to receive a portion of the electronic device; and a compressive member configured to securely retain the portion of the electronic device within the port. In various embodiments, the apparatus may comprise a plurality of ports.

In an embodiment, one of the opposing surfaces may include an area sufficient to receive a label. In another embodiment, one of the opposing surfaces may include a design for engaging with another surface.

In an embodiment, the compressive member may comprise a compressive material. In various embodiments, the compressive member may comprise a flexing member. In an embodiment, the flexing member may comprise a flange configured to flex into a void. In another embodiment, first and second substantially parallel flanges may define opposing boundaries of the port.

In another aspect, the present disclosure is directed to a system for securing an electronic device, the system comprising a first surface; a raised portion associated with the first surface and having a port configured to receive a portion of the electronic device; and an area on the first surface adjacent to the raised portion on which printed material may be provided. In an embodiment, the raised portion may be integral with the first surface. In another embodiment, the raised portion may be provided by a mechanism coupled to the first surface.

In various embodiments, the system may comprise a second surface positioned above the raised portion and in opposed relation to the first surface. In an embodiment, the first and second surfaces may be connected by a spine. In another embodiment, a thickness of the raised portion may define a space between the first and second surfaces when brought together. In yet another embodiment, the first and second surfaces may define opposing inner surfaces of a package member, and the raised portion may provide resistance against external forces on the package member that may damage the electronic device or the package member.

In various embodiments, the raised portion may be placed to maximize the area on which material may be provided without interruption. In an embodiment, the raised portion may be positioned along an outer edge of the first surface. In another embodiment, the port may be positioned to receive the electronic device such that the electronic device is positioned along an outer edge of the first surface. In yet another embodiment, the raised portion and the port may be placed such that the area on which printed material may be provided is not obscured by the electronic device when received by the port

In yet another aspect, the present disclosure is directed to a method for securing an electronic device, the method comprising providing a structure having a port for receiving a portion of an electronic device; inserting the portion of the electronic device into the port; and applying a compressive force within the port in a manner to restrict movement of the electronic device.

In an embodiment, in the step of providing, the structure may be a package member. In another embodiment, in the step of providing, the structure may be an apparatus which can subsequently be coupled to a package member. In yet another embodiment, the structure may be positioned between inner surfaces of a folding binder.

### BRIEF DESCRIPTION OF DRAWINGS

For a more complete understanding of this disclosure, reference is now made to the following description, taken in conjunction with the accompanying drawings, in which:

FIG. 1 depicts a representative commercially available electronic device.

FIG. 2 depicts a perspective view of an apparatus for securing an electronic device, in accordance with one embodiment of the present disclosure.

FIG. 3A depicts a side view of an apparatus for securing an electronic device, in accordance with one embodiment of the present disclosure.

FIG. 3B depicts a top view of the apparatus of FIG. 3A, in accordance with one embodiment of the present disclosure.

FIG. 3C depicts a bottom view of the apparatus of FIG. 3A, in accordance with one embodiment of the present disclosure.

FIG. 4A depicts a cross-sectional view, taken along section line 4A-4A, of an apparatus for securing an electronic device, in accordance with one embodiment of the present disclosure.

FIG. 4B depicts a cross-sectional view, taken along section line 4B-4B, of the apparatus of FIG. 4A, in accordance with one embodiment of the present disclosure.

FIG. 4C depicts a cross-sectional view, taken along section line 4C-4C, of the apparatus of FIG. 4A, in accordance with one embodiment of the present disclosure.

FIG. 4D depicts a cross-sectional view, taken along section line 4C-4C, of an apparatus for securing an electronic device, in accordance with another embodiment of the present disclosure.

FIG. 5A depicts a cross-sectional view, taken along section line 4C-4C, of an apparatus for securing an electronic device, in accordance with one embodiment of the present disclosure.

FIG. 5B depicts a cross-sectional view, taken along section line 4C-4C, of an apparatus for securing an electronic device, in accordance with another embodiment of the present disclosure.

FIG. 5C depicts a cross-sectional view, taken along section line 4C-4C, of an apparatus for securing an electronic device, in accordance with yet another embodiment of the present disclosure.

FIG. 6A depicts a perspective view of an apparatus for securing a plurality of electronic devices, in accordance with one embodiment of the present disclosure.

FIG. 6B depicts a perspective view of an apparatus for securing a plurality of electronic devices, in accordance with another embodiment of the present disclosure.

FIG. 7 depicts a top view of a system for securing an electronic device, in accordance with one embodiment of the present disclosure.

FIG. 8A depicts a top view of a system for securing an electronic device, in accordance with one embodiment of the present disclosure.

FIG. 8B depicts a side view of the system of FIG. 8A, in accordance with one embodiment of the present disclosure.

### DESCRIPTION OF SPECIFIC EMBODIMENTS

### Apparatus 200

Embodiments of the present disclosure generally provide an apparatus 200 for securing an electronic device 100.

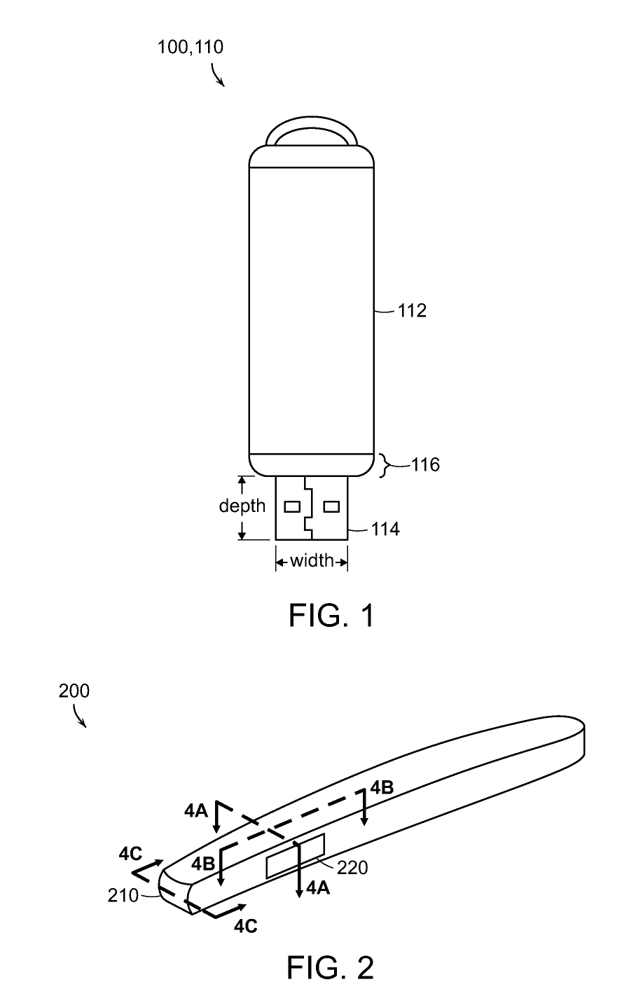

FIG. 1 depicts a representative commercially available electronic device 100. Electronic device 100 may comprise any electronic memory device, electronic connectors (including wireless and cables), electronic peripheral, and the like. In an embodiment, electronic device 100 may comprise a memory stick 110 having a body 112 for housing electronic data storage components, and a head 114 for interfacing with a source/recipient of electronic data (such as a computer port). In another embodiment, electronic device 100 may comprise a memory card. In yet another embodiment, electronic device 100 may comprise an electronic connector having a body for housing data conversion and transmission components and one or more heads for interfacing with a source/recipient of electronic data (such as a computer port, television port, or a peripheral device). Illustrative examples of an electronic connector may include, but are not limited to, devices such as adapters, cables, and wireless transmission devices such as Google Chromecast, Roku Streaming Stick, Actiontec ScreenBeam Wireless Display Adapter, or the like. In various embodiments, electronic device 100 may be configured to connect with other electronics through industry standard connections such as Universal Serial Bus (USB), High-Definition Multimedia Interface (HDMI), FireWire, Serial Port, S-Video, VGA, Ethernet, 802.xx Wi-Fi, BlueTooth, and the like. One having ordinary skill in the art will recognize that the previously-referenced wired and wireless connection standards are merely illustrative, and the present disclosure should not be limited an electronic device configured to connect with other electronics using these or any particular wired/wireless connection standard existing at the time of filing of this application or developed in the future.

FIGS. 2-6B illustrate representative configurations of apparatus 200 and parts thereof, in connection with various embodiments of the present invention. It should be understood that the components of apparatus 200 and parts thereof shown in FIGS. 2-6B are for illustrative purposes only, and that any other suitable components or subcomponents may be used in conjunction with or in lieu of the components comprising apparatus 200 and the parts of apparatus 200 described herein.

Embodiments of apparatus 200 may provide for securely receiving a portion of electronic device 100. Throughout the present disclosure, memory stick 110 may be referred to as a representative example of electronic device 100, and head 114 thereof referenced as a representative portion to be securely received. It should be understood that such references are for illustrative purposes only, and that the present disclosure should not be limited to this context alone. FIG. 2 depicts an embodiment of apparatus 200 that may comprise a body 210, a port 220 extending into body 210, and a compressive member 230 (not shown), as described in more detail herein.

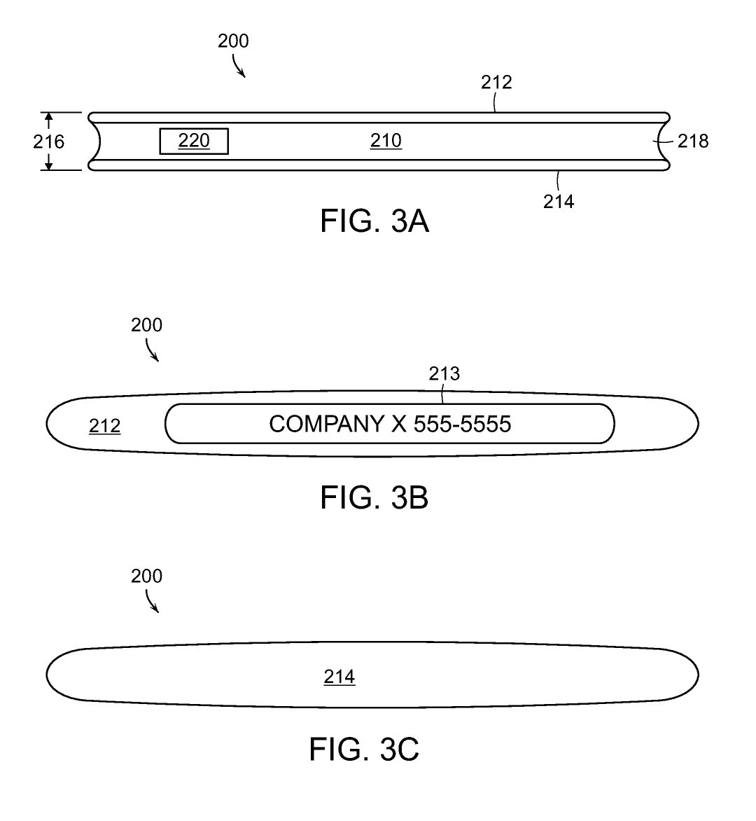

Referring now to FIGS. 3A-C, apparatus 200 may comprise a body 210. Body 210 may be of any size, shape, material, and construction suitable to include one or more ports 220 therein. In various embodiments, body 210 may be rigid, semi-rigid, or comprise a combination of elements having rigid and semi-rigid constructions. Body 210 may comprise any suitable material including, but not limited to, plastic, wood, or metal (considering, of course, any impacts of potential magnetic or electro-static charges on electronic device 100), and may be formed via any suitable manufacturing method, such as injection molding, extrusion, additive methods (3-D printing, etc.), and the like. In various embodiments, it may be desirable to provide body 210 with a lightweight construction, thereby minimizing the weight of apparatus 200 and any system in which apparatus 200 may be included.

Referring now to FIG. 3A, body 210 may comprise opposing surfaces 212, 214. Referring now to FIG. 3B, in various embodiments, surface 212 an area for receiving a label 213, or otherwise display information such as words, numbers, characters, symbols, logos, etc. In an embodiment, surface 212 may be flat and/or smooth, thereby providing an area conducive to receiving a wrinkle-free label. In another embodiment, the display may be formed on or into surface 212—that is, the information may be set forth in raised or imprinted characters via any suitable process such as molding, etching, or the like. It should be appreciated that the area for receiving label 213 can be a portion of surface 212.

Referring now to FIG. 3C, in various embodiments, surface 214 may be configured for attachment to a surface of another object. In an embodiment, surface 214 may include a contour or any design corresponding with a surface to which it may attach. For example, if the surface of the other object is flat, surface 214 may be flat; if the other surface is curved, surface 214 may comprise a similar contour for flush mating. In another embodiment, surface 214 may comprise a texture suitable for coupling with a surface of another object. For example, surface 214 may be smooth or scored depending on the surface with which it may attach and the adhesive (or other suitable coupler) used to attach surface 214 thereto. In yet another embodiment, surface 214 may be configured to receive or project one or more coupling mechanisms such as clips, pegs, etc. that may be used to couple surface 214 to a surface of another object.

Referring back to FIG. 3A, body 210, in one embodiment, may have a thickness 216 extending between opposing surfaces 212, 214. In an embodiment, thickness dimension 216 may be greater than that of a portion of an electronic device 100 to be secured. In another embodiment, thickness dimension 216 may be substantially similar to that of the electronic device 100 itself. In certain embodiments, body 210 may be substantially solid, substantially hollow, or a combination thereof along the thickness dimension between surfaces 212 and 214. In various embodiments, a surface 218 may extend between opposing surfaces 212, 214 about at least a portion of a perimeter of body 210.

Although illustrated as a standalone apparatus, it should be appreciated that apparatus 200, in one embodiment, can be integral (i.e., formed as part of) with another object, such as package member 300 (later described). In such an embodiment, surface 214 of apparatus 200 may, for example, be integral with a surface of package member 300. Furthermore, it should be recognized that, in such an embodiment, the entirety of apparatus 200 may be made of the same or similar materials of the other object and may be formed as part of the other object, so as to be integrated with the other object rather that formed as a standalone piece that is ultimately attached to the other object.

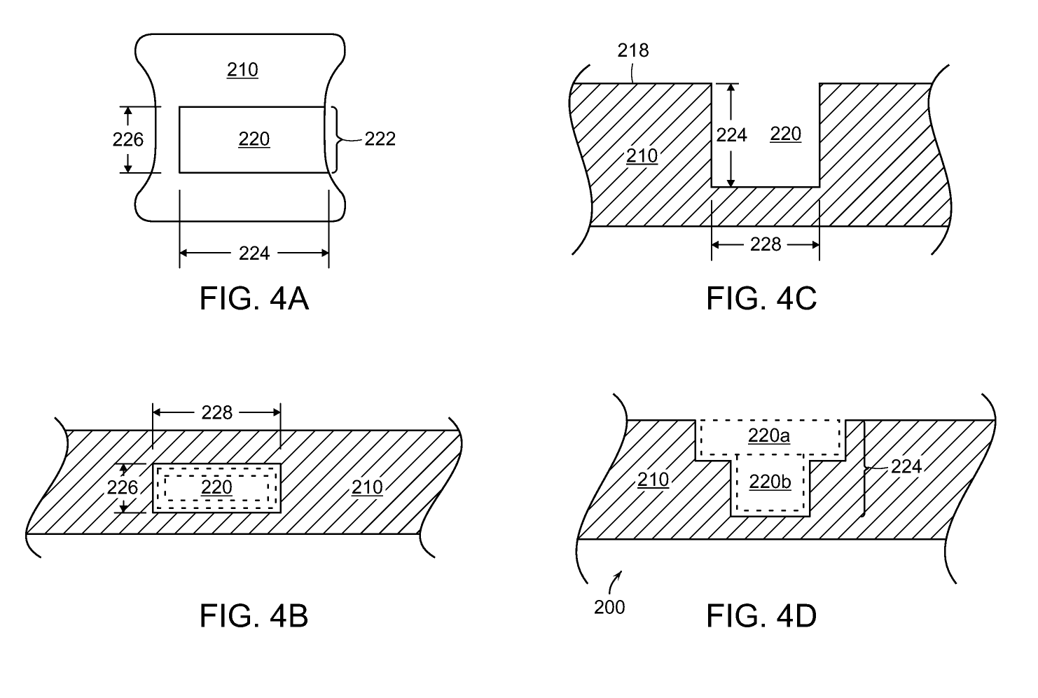

Referring now to FIGS. 4A-C, apparatus 200 may further comprise one or more ports 220 for receiving electronic device 100. Port 220 may comprise an opening 222 disposed at a periphery of body 210. In various embodiments, opening 222 may extend through surface 218, and port 220 may extend therefrom into body 210 between opposing surfaces 212, 214. In another embodiment, port 220 may extend into, but not all the way through, body 210. In yet another embodiment, port 220 may extend all the way through body 210, thereby forming a second corresponding opening in a periphery of body 210 (not shown) at a distal end of port 220.

It should be recognized that port 220 need not be defined by physical boundaries along its entirety. For example, in an embodiment, at least a portion of body 210 immediately surrounding port 220 may be substantially hollow, and port 220 may be generally defined by opening 222 and a hollow volume naturally extending into body 210 therefrom. It should be further recognized that, in some embodiments (later described), a compressive member 230 may define at least a partial boundary of port 220. Still further, it should be recognized that port 220 may undergo changes in shape and/or dimensions in connection with receiving a portion of an electronic device as later described.

Port 220 may comprise any shape and dimensions suitable to receive a portion of an electronic device 100 to be secured. Referring to FIGS. 4A and 4B, port 220 may comprise any thickness dimension 226 suitable to receive a portion of electronic device 100 to be secured. For example, in an embodiment configured to receive a head portion 114 of a memory stick 110, port thickness dimension 226 may be substantially similar to or larger than that of head 114 of memory stick 110. Referring to FIGS. 4A and 4C, port 220 may similarly comprise any depth dimension 224 suitable to receive a portion of electronic device 100 to be secured. For example, in an embodiment configured to receive a head portion 114 of a memory stick 110, port depth dimension 224 may be substantially similar to or larger than that of head 114 of memory stick 110. Referring to FIGS. 4B and 4C, port 220 may similarly comprise any width dimension 228 suitable to receive a portion of electronic device 100 to be secured. For example, in an embodiment configured to receive a head portion 124 of a memory stick 110, port width dimension 228 may be substantially similar to or larger than that of head 114 of memory stick 110. It should be recognized that, in embodiments comprising port 220 having dimensions substantially similar to the portion of electronic device 100 to be received, a friction fit may be formed between port 220 and that electronic device portion. A friction fit may provide for releasably coupling electronic device 100 with apparatus 200.

In various embodiments, the overall internal shape of port 220 may be configured to substantially match that of the overall external shape of the portion of the electronic device 100 to be received. For example, in an embodiment configured to receive a USB head portion 114, port 220 may be substantially rectangular in cross section as shown in FIGS. 4A-4C. Of course, the shape and dimensions of port 220 may be configured to receive other portions of electronic device 100, as well as other head styles. For example, in an embodiment configured to receive an HDMI head portion 124, port 220 may comprise a substantially trapezoidal cross section similar to that of an HDMI head, rather than a substantially rectangular cross section of a USB head.

Referring now to FIG. 4D, one having ordinary skill in the art will recognize that the shape and dimensions of port 220 need not be uniform throughout port 220. For example, in an embodiment configured to receive both head 114 and shoulders 116 (see FIG. 1) of memory stick 110, port 220 may comprise a stepped cross section having a first substantially rectangular portion 220a having dimensions substantially similar to or larger than those of shoulders 116, and a second substantially rectangular portion 220b having dimensions substantially similar to or larger than those of head 114.

Referring back to FIG. 4C, in various embodiments, surface 218 may be configured for flush contact with a surface of the remaining portion of electronic device 100. For example, in an embodiment configured to receive head 114 of a memory stick 110, surface 218 may be substantially perpendicular to port 220 in a region proximate to opening 222 so as to provide flush contact with shoulders 116 of body 112 when head 114 is inserted therein.

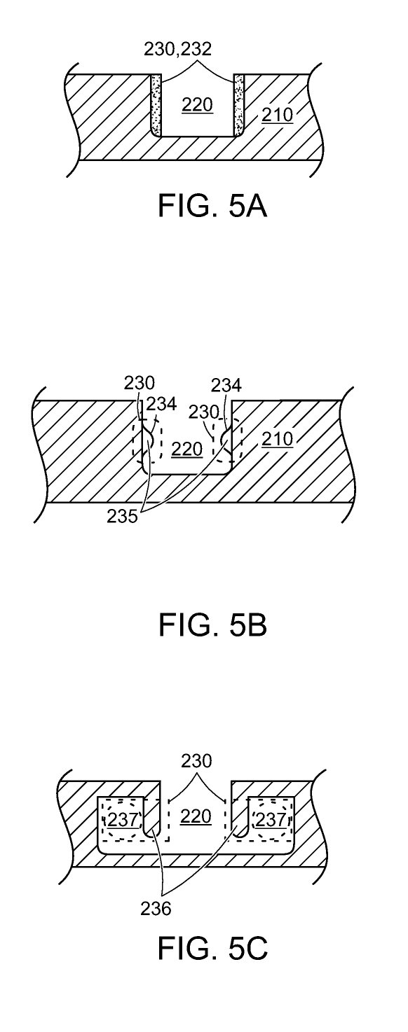

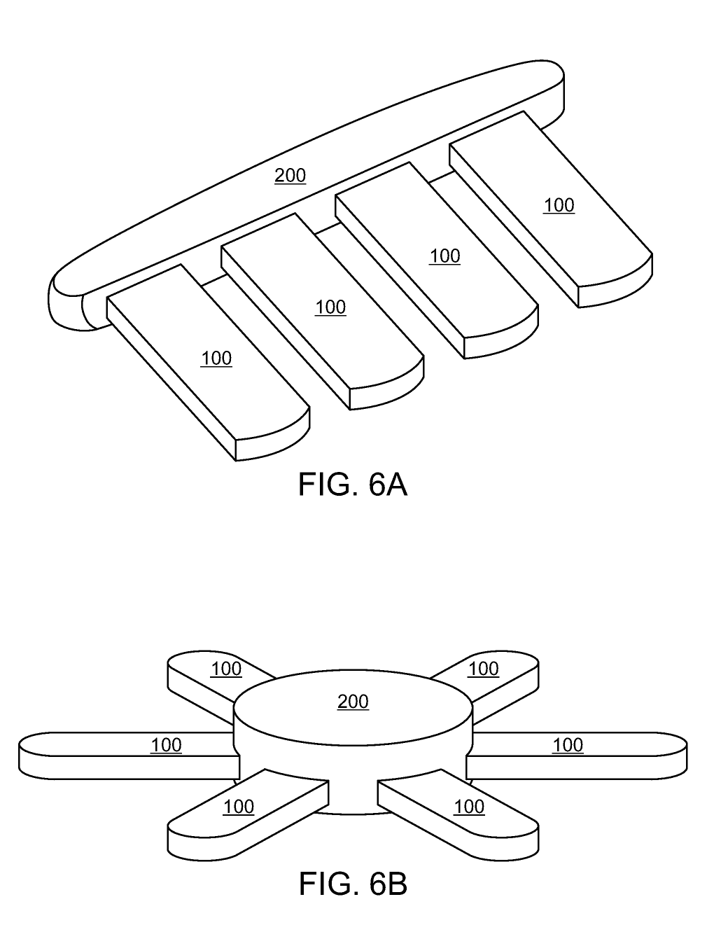

Referring now to FIGS. 5A-C, in various embodiments, apparatus 200 may further comprise a compressive member 230. As previously mentioned, compressive member 230 may form a boundary of port 220, and may comprise any material or mechanism configured to flex, warp, or otherwise change shape and/or dimensions in response to insertion of a portion of the electronic device 100 into port 220. Compressive member 230 may define a boundary of port 220 in such a manner such that all or a portion of port 220 has smaller dimensions in a neutral state than those of a portion of electronic device 100 to be secured therein. In these ways, compressive member 230 may apply a compressive force on the inserted portion of electronic device 100. In various embodiments, this compressive force may comprise a component normal to the path of insertion/removal of the electronic device portion into/from port 220.

Referring to FIG. 5A, compressive member 230 may comprise a compressible material 232, such as foam, rubber, or any material capable of being compressed. Compressible material 232 may be configured to compress from a neutral state when a portion of electronic device 100 is inserted into port 220, and thereby apply a resulting equal and opposite compressive force on the received portion of electronic device 100. Compressible material 232 may be further configured to expand back to a neutral state upon removal of a portion of electronic device 100 from port 220. In various embodiments, compressible material 232 may be disposed about all or a portion of an outer boundary of port 220. In an embodiment, a majority or entirety of body 210 may comprise compressible material 232, rendering compressive member 230 somewhat undistinguishable from body 210. In another embodiment, compressible material 232 may be distinguishable from body 210, and may be situated in a region about an outer boundary of port 220. One having ordinary skill in the art will recognize a desirable configuration of compressive member 232 about passage 220 for a given application within the scope of this disclosure.

Referring to FIGS. 5B and 5C, compressive member 230 may comprise one or more flexing mechanisms 234. Flexing member 234 may be configured to flex outward from a neutral state when a portion of electronic device 100 is inserted into port 220, and thereby apply a resulting equal and opposite compressive force on the received portion of electronic device 100. Flexing member 234 may be further configured to flex back to a neutral state upon removal of a portion of electronic device 100 from port 220. In various embodiments, compressive member 230 may comprise one or more voids 235 into which flexing member 234 may flex. Referring to FIG. 5B, in an embodiment, flexing member 234 may comprise a rounded spring member and a corresponding number of adjacent voids. The rounded spring member may form a boundary of port 220, and be configured to flex outward into adjacent void upon insertion of the portion of the electronic device 100 to be secured. In an embodiment, the rounded spring member may elongate (via outward translation of non-fixed ends) and thereby flex into an adjacent void. In another embodiment, the rounded spring member may warp and flex into an adjacent void. Referring to FIG. 5C, in an embodiment, flexing member 234 may comprise one or more flanges 236 and a corresponding number of adjacent voids 237. Flange 236 may form a boundary of port 220, and be configured to flex outward into adjacent void 237 upon insertion of the portion of the electronic device 100 to be secured. In various embodiments, apparatus 200 may comprise multiple flexing members 234. In an embodiment, flexing members 234 may be arranged about port 220 in a common plane and substantially opposite one another. In another embodiment, flexing members 234 may be arranged about port 220 in different planes. One having ordinary skill in the art will recognize a desirable type, number and arrangement of flexing members 234 in association with passage 220 for a given application within the scope of this disclosure.

As previously described, compressive member 230 may define a boundary of port 220 in such a manner such that all or a portion of port 220 has smaller dimensions in a neutral state than those of a portion of electronic device 100 to be secured therein. Depending on the shape of port 220 in a neutral state, as well as the manner and extent to which compressive member 230 may flex, warp, or otherwise change shape and/or dimensions in response to insertion of a portion of the electronic device 100 into port 220, various types of electronic devices 100 may be secured in a single port 220/compressive member 230 configuration. For example, an embodiment comprising a port 220 having a substantially rectangular shaped cross section as viewed along section line A-A and a compressive member 230 of suitable compressibility or flexibility may be configured to securely receive various heads 114 having somewhat similar shapes and dimensions, such as USB and HDMI. In an embodiment, such a configuration may enable apparatus 200 to have broader use and appeal.

Compressive member 230 may be configured to securely retain a portion of electronic device 100 within port 220. In various embodiments, a compressive force exerted by compressive member 230 on electronic device 100 may generate or amplify a frictional force acting to securely retain electronic device 100. Friction is proportional to a coefficient of friction, μ, between objects, and a normal force, N, pressing the objects together. Accordingly, an increase in either value will increase the frictional force on the portion of electronic device 100 in contact with compressive member 230. Through application of a compressive force having a component normal to the direction of insertion/removal of electronic device 100 into/from port 220, respectively, compressive member 230 serves to increase the frictional force securing the device 100 within port 220. Similarly, in various embodiments, compressive member 230 may comprise a material having a relatively high coefficient of friction, thereby also serving to increase the frictional force used to secure the device 100 within port 220.

Referring now to FIGS. 6A and 6B, apparatus 200 may comprise numerous suitable combinations of the aforementioned elements for securing one or more electronic devices 100. Referring to FIG. 6A, in an embodiment, apparatus 200 may comprise multiple ports 220 (and corresponding compressive members 230) distributed along a length of an elongated body 210 for securing a corresponding number of electronic devices 100 thereto. Referring to FIG. 6B, in an embodiment, apparatus 200 may comprise multiple ports 220 (and corresponding compressive members 230) distributed about a circumference of a circular body 210 for securing a corresponding number of electronic devices 100 thereto. One having ordinary skill in the art will recognize a desirable combination of body 210, ports 220, and compressive members 230 as described herein for a given application within the scope of this disclosure.

### System 400

Embodiments of the present disclosure generally provide a system 400 for securing an electronic device 100.

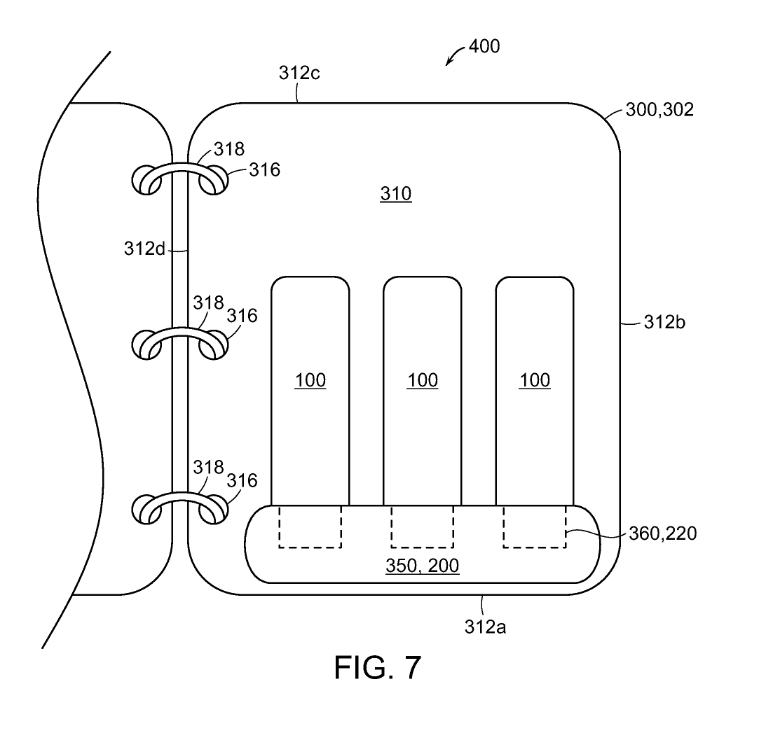

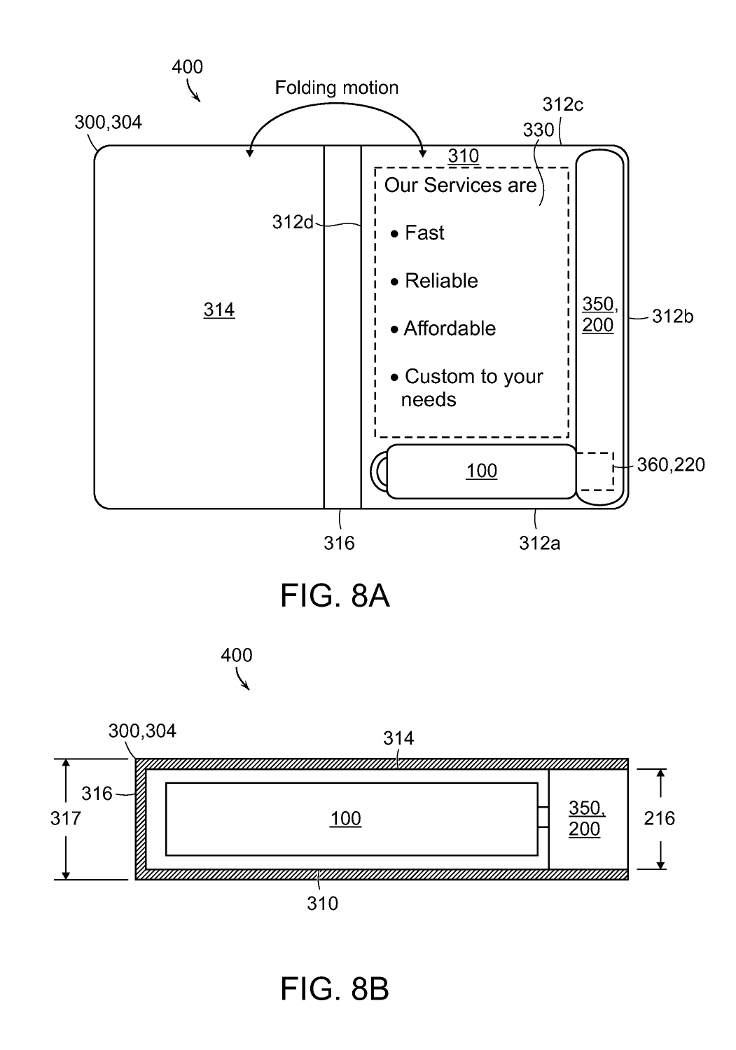

FIGS. 7-8B illustrate representative configurations of system 400 and parts thereof. It should be understood that the components of system 400 and parts thereof shown in 7-8B are for illustrative purposes only, and that any other suitable components or subcomponents may be used in conjunction with or in lieu of the components comprising system 400 and the parts of system 400 described herein.

Embodiments of system 400 may provide for securely receiving a portion of electronic device 100. FIGS. 7-8B depict embodiments of system 400 that may comprise a package member 300. Package member 300 may be of any size, shape, material, and construction, and may comprise a surface 310. In an embodiment, system 400 may comprise a single package member 300. In another embodiment, system 400 may comprise multiple package members 300 in association with one another.

System 400 may further comprise a raised portion 350 associated with surface 310 and having a port 360 configured to receive a portion of electronic device 100. In an embodiment, raised portion 350 may comprise a mechanism coupled to surface 310, such as apparatus 200. Of course, raised portion 350 may comprise any suitable mechanism for securely receiving a portion of electronic device 100, not just apparatus 200. In another embodiment, raised portion 350 may be a portion of surface 310 itself that projects above other portions of surface 310, and may define a space within package member 300 into which port 360 extends. In such an embodiment, raised portion 350 and port 360 may be considered to be integral with surface 310. Integration may be valuable from an aesthetics perspective as it creates the appearance of one seamless package. Additionally, in some embodiments, that manufacturing process may be more streamlined for integral embodiments. Still further, integration may provide for a more robust product—for example, while a weak coupling, physical impact, wetness or other circumstance may cause apparatus 200 (or any other suitable mechanism) to become dislodged from package member 300 in non-integral embodiments, an integral construction would be more likely to remain intact.

For the sake of consistent description only, apparatus 200 may be used as an exemplary embodiment of raised portion 350 to further describe system 400; likewise, port 360 may be referred to in terms of port 220 of apparatus 200. It should be recognized, however, that embodiments of system 400 may comprise any suitable structure configured to receive a portion of electronic device 100, and that said structure may be either coupled to or integral with surface 310 as previously described. Accordingly, the present disclosure should not be limited only to embodiments of system 400 comprising apparatus 200.

Referring now to FIG. 7, in various embodiments, package member 300 may comprise a substantially flat piece of material 302. Flat piece 302 may comprise a surface 310, comprising edges 312a, 312b, 312c, and 312d. One having ordinary skill in the art will recognize that flat piece 302 may comprise any suitable shape, and that surface 310 may comprise any number of edges 312 in any suitable configuration. In various embodiments, system 400 may comprise multiple flat pieces 302 in association with one another. In an embodiment, flat pieces 302 may comprise holes 316 configured to receive binder rings 318, thereby enabling multiple flat pieces 310 to be coupled for possible use in a media storage binder embodiment of system 400 similar to CD/DVD storage binders as shown in FIG. 7. In another embodiment, multiple flat pieces 302 may be configured for stacking on top of one another, which may be potentially useful in a shipping context.

Referring now to FIG. 8A, in various embodiments, package member 300 may comprise a folding binder 304. Folding binder 304 may comprise a surface 310 having edges 312a, 312b, 312c, 312d. One having ordinary skill in the art will recognize that folding binder 302 may comprise any number of edges 312 in any suitable configuration. Folding binder 304 may further comprise surface 314. Surface 314 may be situated opposite surface 310 when folding binder 304 is folded closed as shown in FIG. 8B. In various embodiments, a spine 316 may connect surface 310 and surface 314.

Referring to FIGS. 7-8B, system 400 may comprise numerous configurations of apparatus 200 suitable for securing one or more electronic devices 100. In various embodiments, apparatus 200 may comprise dimensions and a shape suitable to fit completely on surface 310 of package member 300. In an embodiment, apparatus 200 may have dimensions and shape suitable to align with an outer edge 312 of surface 310. For example, referring to FIG. 7, apparatus 200 may comprise an elongated shape having dimensions and contour suitable to align with an outer edge 312a of surface 310 of flat piece 302. Similarly, referring to FIG. 8A, apparatus 200 may comprise an elongated shape having dimensions and contour suitable to align with outer edge 312b of surface 310 of folding binder 304. Referring back to FIG. 7, in yet another embodiment, apparatus 200 may comprise dimensions, shape, and a port configuration suitable to secure multiple electronic devices 100. For example, apparatus 200 may comprise ports 220 (and corresponding compressive members 230) distributed along elongated body 210, the length of body 210 and number of ports 220 corresponding with a number and dimensions of electronic devices 100 to be secured thereto.

Referring to FIGS. 7-8B, system 400 may further comprise numerous layout configurations of apparatus 200 on package member 300 as well. In various embodiments, surface 214 of apparatus 200 may be coupled with surface 310 of flat piece 302 as shown in FIG. 7, or with surface 310 of binder 304 as shown in FIG. 8A. In various embodiments, apparatus 200 may be configured and positioned on surface 310 in a manner suitable to fit one or more electronic devices 100 completely thereon. In various embodiments, apparatus 200 may be positioned along and align with an outer edge of surface 310. In such an embodiment, opening(s) 222 of port(s) 220 may be directed inward from outer edge 312 of surface 310. Further, apparatus 200 and port 220 may be placed in a manner suitable to align electronic device 100 along an outer edge 312 of surface 310. Referring to FIG. 8A, in an embodiment, a corresponding port 220 may be located and oriented within apparatus 200 and apparatus 200 placed on package member surface 310 in a manner suitable to align electronic device 100 along outer edge 312b.

Apparatus 200 may be placed in a manner sufficient to restrict movement of electronic device 100 secured thereto. In various embodiments, placing may comprise coupling apparatus 200 to surface 310. In an embodiment, apparatus 200 may be coupled to surface 310 such that an unsecured portion of electronic device 100 rests against surface 310. In another embodiment, apparatus 200 may be coupled to surface 310 of folding binder 304 such that an exposed portion of electronic device 100 rests against at least that surface, and possibly the opposing surface. It should be recognized that placing apparatus 200 in a manner to restrict movement of the device need not entail supporting device 100 against another structure. Even though such a configuration may help prevent the exposed portion of device 100 from moving (i.e. bending) relative to the secured portion, simply coupling apparatus 200 with another structure may effectively restrict movement of electronic device 100 overall.

In various embodiments, placement of certain configurations of apparatus 200 on package member 300 may result in embodiments of system 400 having particularly useful characteristics. In some aspects, apparatus 200 may resist external forces on package member 300 that may damage electronic device 100 or package member 300 itself. For example, referring to FIG. 8B, apparatus 200 may define a protective space between surfaces 310, 314 when brought together and provide resistance against external forces on package member 300 that may damage electronic device 100 or package member 300. Still referring to FIG. 8B, spine 316 may be characterized by a width dimension 317. In an embodiment, apparatus 200 may have thickness 216 substantially similar to width 317 of spine 316—such an arrangement may provide a space between surfaces 310, 314 having uniform dimensions. In this configuration, apparatus 200 causes surfaces 310, 314 to stop closing upon reaching an orientation substantially perpendicular to spine 316, thereby generating a rectangular shaped gap of uniform thickness between surfaces 310, 314 as shown in FIG. 8B. In one aspect, such a system may better protect electronic device 100 and package member 300, and in another aspect, may have improved stackability for storage or shipping given its symmetric rectangular cross-section when closed.

Placement of apparatus 200 may provide for efficient use of space available on surface 310. In one aspect, alignment of apparatus 200 along an outer edge 312 of surface 310 may provide for using a smaller package member 300 for a given number of devices 100 to be secured. For example, surface 310 need only be wide enough to accommodate a depth of apparatus 200 and a length of body 110 of device 100 as shown in FIG. 8A.

In another aspect, referring to FIG. 8A, placement of apparatus 200 may provide an area 330 on surface 310 adjacent to apparatus 200 on which printed material may be provided. In various embodiments, apparatus 200 may be placed to maximize size of area 330 and provide for area 330 to be uninterrupted by the presence of apparatus 200 or electronic device 300 when secured thereto. For example, still referring to FIG. 8A, apparatus 200 may be placed along an outer edge 312, thereby leaving a large, uninterrupted area 330 of surface 310 exposed. Additionally, apparatus 220 and/or port 220 may be positioned such that electronic device 100 is positioned along an outer edge 312 of surface 310. In this way, electronic device 100 will not obscure (i.e., interrupt) area 330. It should be recognized that alternative arrangements may provide a large, uninterrupted area 330 on which materials may be printed, and that the present disclosure should not be limited to just those example arrangements provided herein. Space 330 may be useful for displaying marketing materials or other information to accompany electronic device 100. Provision of a large, uninterrupted space may be ideal for presenting said marketing materials in a coherent and attractive manner.

While the present invention has been described with reference to certain embodiments thereof, it should be understood by those skilled in the art that various changes may be made and equivalents may be substituted without departing from the true spirit and scope of the invention. In addition, many modifications may be made to adapt to a particular situation, indication, material and composition of matter, process step or steps, without departing from the spirit and scope of the present invention. All such modifications are intended to be within the scope of the claims appended hereto.

What is claimed is:

1. An apparatus for securing an electronic device, the apparatus comprising:
a body having opposing surfaces;
a port extending into the body and configured to receive a portion of the electronic device; and
a compressive member configured to securely retain the portion of the electronic device within the port.

2. An apparatus as set forth in claim 1, wherein one of the opposing surfaces includes an area sufficient to receive a label.

3. An apparatus as set forth in claim 1, wherein one of the opposing surfaces includes a design for engaging with another surface.

4. An apparatus as set forth in claim 1, wherein the compressive member comprises a compressive material.

5. An apparatus as set forth in claim 1, wherein the compressive member comprises a flexing member.

6. An apparatus as set forth in claim 5, wherein the flexing member comprises a flange configured to flex into a void.

7. An apparatus as set forth in claim 6, comprising first and second substantially parallel flanges defining opposing boundaries of the port.

8. An apparatus as set forth in claim 1, comprising a plurality of ports.

9. A system for securing an electronic device, the system comprising:
a first surface;
a raised portion associated with the first surface and having a port configured to receive a portion of the electronic device; and
an area on the first surface adjacent to the raised portion on which printed material may be provided.

10. A system as set forth in claim 9, wherein the raised portion is integral with the first surface.

11. A system as set forth in claim 9, wherein the raised portion is provided by a mechanism coupled to the first surface.

12. A system as set forth in claim 9, further including a second surface positioned above the raised portion and in opposed relation to the first surface.

13. A system as set forth in claim 12, wherein the first and second surfaces are connected by a spine.

14. A system as set forth in claim 13, wherein a thickness of the raised portion defines a space between the first and second surfaces when brought together

15. A system as set forth in claim 14, wherein the first and second surfaces define opposing inner surfaces of a package member, and wherein the raised portion provides resistance against external forces on the package member that may damage the electronic device or the package member.

16. A system as set forth in claim 9, wherein the raised portion is placed to maximize the area on which material may be provided without interruption.

17. A system as set forth in claim 16, wherein the raised portion is positioned along an outer edge of the first surface.

18. A system as set forth in claim 16, wherein the port is positioned to receive the electronic device such that the electronic device is positioned along an outer edge of the first surface.

19. A system as set forth in claim 16, wherein the raised portion and the port are placed such that the area on which printed material may be provided is not obscured by the electronic device when received by the port.

20. A method for securing an electronic device, the method comprising:
providing a structure having a port for receiving a portion of an electronic device;
inserting the portion of the electronic device into the port; and
applying a compressive force within the port in a manner to restrict movement of the electronic device.

21. A method as set forth in claim 20, wherein, in the step of inserting, the portion comprises a head of the electronic device.

22. A method as set forth in claim 20, wherein in the step of providing, the structure is a package member.

23. A method as set forth in claim 20, wherein in the step of providing, the structure is an apparatus which can subsequently be coupled to a package member.

24. A method as set forth in claim 20, further including positioning the structure between inner surfaces of a folding binder.
